(19) United States
(12) Patent Application Publication
(10) Pub. No.: US 2023/0289609 A1
(43) Pub. Date: Sep. 14, 2023

(54) As-Light-As-Possible Autoencoder Neural Network

(71) Applicant: Artificial Intelligence Foundation, Inc., Las Vegas, NV (US)

(72) Inventors: Gaurav Bharaj, San Francisco, CA (US); Nisarg Shah, Ahmedabad (IN)

(73) Assignee: Artificial Intelligence Foundation, Inc., Las Vegas, NV (US)

(21) Appl. No.: 17/689,940

(22) Filed: Mar. 8, 2022

(51) Int. Cl. G06N 3/08; G06N 3/04

(52) U.S. Cl. CPC G06N 3/088; G06N 3/0454

(57) ABSTRACT

A computer system (which includes one or more computers) that generates a second autoencoder (AE) neural network (such as an ALAP-AE neural network) is described. During operation, the computer system may obtain information specifying an initial AE neural network. Then, the computer system may compute a subset of filters associated with the initial AE neural network to remove based at least in part on a L1-norm loss function and weights associated with filters in initial AE neural network. Moreover, the computer system may prune the subset of the filters from the initial AE neural network. Next, the computer system may generate the ALAP-AE neural network by retraining the initial AE neural network, where the retraining includes a student-teacher model in which the teacher includes the pruned initial AE neural network and the student includes the ALAP-AE neural network.

### FIELD

The described embodiments relate to techniques for generating a second autoencoder neural network based at least in part on a first autoencoder (AE) neural network. Notably, the described embodiments relate to techniques for generating an as-light-as-possible autoencoder (ALAP-AE) neural network based at least in part on an initial autoencoder neural network.

### BACKGROUND

High demand for consumer avatars, telepresence, and portrait enhancement filters (such as toonification, ageing, etc.) has led to an increased at-scale need for photo-realistic image generation. Typically, these applications use neural image generation techniques, such as Generative Adversarial Networks (GANs) and image-to-image style transfer techniques for supervised image and video generation via autoencoders, such as U-nets (from the Computer Science Department and BIOSS Centre for Biological Signaling Studies, University of Freiburg, of Freiburg, Germany).

Moreover, along with advancements in deep learning, the availability of libraries, such as PyTorch (from Meta, Inc., of Menlo Park, California) and Tensorflow (from Alphabet, Inc., of Mountain View, California), have helped achieve photo-realistic image generation. Usually, the backends of these libraries rely on fast tensor operations, parallelized via graphics processing unit (GPU) compute. However, real-time image generation via GAN-like techniques often has a high deployment cost because of high GPU-based instance costs and a high break-even profitability point. Although certain edge devices are native GPUs capable, they can also suffer from slow inference, quality and resolution deterioration of generated images. Thus, there is typically a need for a solution that can quickly optimize a neural network for a given compute device, without sacrificing image quality and that provides faster inference capabilities.

A variety of approaches are being studied to address these challenges, including: neural architecture design, network architecture search (NAS), and/or neural-net compression (e.g., quantization, distillation, and/or pruning). However, these techniques usually do not directly optimize model architectures for a given device, and target generic lightweight compute capability for cloud, workstation, or edge compute devices. For example, an efficient neural-net architecture for GPU-CPU compute may not run efficiently on CPU-only compute. Moreover, manual neural architecture design is often difficult and usually is not device-specific. Furthermore, while NAS may be employed for device specific neural-net design, such a search is often expensive and requires a very large amount of compute and time, which is not suitable for optimizing a neural network on a typical computer.

Additionally, neural-net model compression techniques usually focus on image classification and detection and are typically not directly useful for (conditional) GAN autoencoder compression tasks. While compression techniques for conditional GAN-based semantic segmentation exits, these techniques often result in poor quality photo-realistic image generation. For example, a proposed GAN compression evolutionary search technique based on channel pruning is specifically designed for cyclic-consistency based image generation, and it is nontrivial to extend this approach to non-cyclic consistency GANs. Moreover, generators compressed by classifier compression techniques typically suffer performance decay compared with the original generator. Alternatively, while a more general-purpose GAN compression technique has been proposed by training an efficient generator by model distillation and removing the dependency on cyclic consistency, the student network in this approach is handcrafted and usually requires significant architectural engineering for good performance.

### SUMMARY

A computer system that generates a second AE neural network (such as an ALAP-AE neural network) is described. This electronic device includes: a computation device (such as one or more processors and/or one or more GPUs); and memory that stores program instructions that are executed by the computation device. During operation, the computer system obtains information specifying an initial AE neural network. Then, the computer system computes a subset of filters associated with the initial AE neural network to remove based at least in part on a L1-norm loss function and weights associated with filters in initial AE neural network. Moreover, the computer system prunes the subset of the filters from the initial AE neural network. Next, the computer system generates the ALAP-AE neural network by retraining the initial AE neural network, where the retraining includes a student-teacher model in which the teacher includes the pruned initial AE neural network and the student includes the ALAP-AE neural network.

Note that obtaining the initial AE neural network may include: accessing the information specifying the initial AE neural network stored in memory associated with the computer system; training the initial AE neural network; or receiving, from another computer system, the information specifying the initial AE neural network.

Moreover, the initial AE neural network may transform an input image to a latent space, and from the latent space back to an output image.

Furthermore, the subset of filters associated with the initial AE neural network to remove are not activated or have a subset of the weights less than a predefined value.

Additionally, the computation may include regularizing the initial AE neural network to drive a subset of the weights associated with the subset of filters below the predefined value (such as 0). In some embodiments, the regularizing is based at least in part on a number of filters in a given layer of the initial AE neural network. For example, the subset of the weights associated with the subset of filters may be linearly driven below the predefined value based at least in part on the number of filters in the given layer.

Note that the computation may be based at least in part on a type of compute environment in which the ALAP-AE neural network is intended to execute. For example, the type of compute environment may include: one or more processors, and/or one or more GPUs.

Moreover, the initial AE neural network and the ALAP-AE neural network may be trained using a common dataset.

Furthermore, a difference of an image quality of an output of the initial AE neural network and the ALAP-AE neural network may be less than a second predefined value. For example, the second predefined value may be zero. Note that the image quality may include or may correspond to a Frechet Inception Distance (FID).

In some embodiments, a number of non-zero weights in the ALAP-AE neural network may be at least a factor of 10 less than a number of non-zero weights in the weights in the initial AE neural network.

Another embodiment provides a computer-readable storage medium for use in conjunction with the computer system. This computer-readable storage medium includes the program instructions for at least some of the operations performed by the computer system.

Another embodiment provides a method for generating the ALAP-AE neural network. The method includes at least some of the aforementioned operations performed by the computer system.

Another embodiment provides information specifying the ALAP-AE neural network. For example, the information specifying the ALAP-AE neural network may be stored on a second computer-readable medium.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

The included drawings are for illustrative purposes and serve only to provide examples of possible structures and arrangements for the disclosed systems and techniques. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 is a block diagram illustrating an example of a computer system that generates or provides an as light as possible-autoencoder (ALAP-AE) neural network in accordance with an embodiment of the present disclosure.

FIG. 2 is a flow diagram illustrating an example of a method for generating an ALAP-AE neural network in accordance with an embodiment of the present disclosure.

FIG. 3 is a drawing illustrating an example of communication among components in a computer system in FIG. 1 in accordance with an embodiment of the present disclosure.

FIG. 4 is a drawing illustrating an example of a regularization technique for dynamic channel-filter condensing and pruning Generative Adversarial Network (GAN)-based autoencoders (AEs) in accordance with an embodiment of the present disclosure.

FIGS. 5 and 6 are drawings illustrating an example of a weight distribution plot for a layer in a penalization or loss model in accordance with an embodiment of the present disclosure.

FIG. 7 is a block diagram illustrating a computer system in accordance with an embodiment of the present disclosure.

FIG. 8 is a block diagram illustrating a data structure for use in conjunction with the computer system of FIG. 7 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system (which includes one or more computers) that generates a second AE neural network (such as an ALAP-AE neural network) is described. This electronic device may include: a computation device (such as one or more processors and/or one or more GPUs); and memory that stores program instructions that are executed by the computation device. During operation, the computer system may obtain information specifying an initial AE neural network. Then, the computer system may compute a subset of filters associated with the initial AE neural network to remove based at least in part on a L1-norm loss function and weights associated with filters in initial AE neural network. Moreover, the computer system may prune the subset of the filters from the initial AE neural network. Next, the computer system may generate the ALAP-AE neural network by retraining the initial AE neural network, where the retraining includes a student-teacher model in which the teacher includes the pruned initial AE neural network and the student includes the ALAP-AE neural network.

By generating the ALAP-AE neural network, these regularization techniques provide a lightweight neural-network architecture that is customized to a compute environment or a second computer system in which the ALAP-AE neural network is intended to execute. For example, the ALAP-AE neural network may include at least a factor of 10 fewer filters with non-zero weights than the initial AR neural network. Consequently, the cost and complexity of the second computer system may be significantly reduced (e.g., the second computer system may have lightweight compute capability). Moreover, the ALAP-AE neural network may provide photo-realistic images. Notably, the image quality loss (e.g., as measured by the FID) of images produced or provided by the initial AE neural network and the ALAP-AE neural network may be small or zero. Furthermore, the regularization techniques may be performed using a typical computer system (such as a mainstream workstation) instead of requiring specialized (and expensive) processing capabilities, and the ALAP-AE neural network may be rapidly optimized or generated for use on an arbitrary second computer system. Therefore, the regularization techniques may increase the use of the ALAP-AE neural network and may provide an improved user experience.

In the discussion that follows, an individual or a user may be a person. In some embodiments, the regularization techniques are used by a type of organization instead of a user, such as a business (which should be understood to include a for-profit corporation, a non-profit corporation or another type of business entity), a group (or a cohort) of individuals, a sole proprietorship, a government agency, a partnership, etc.

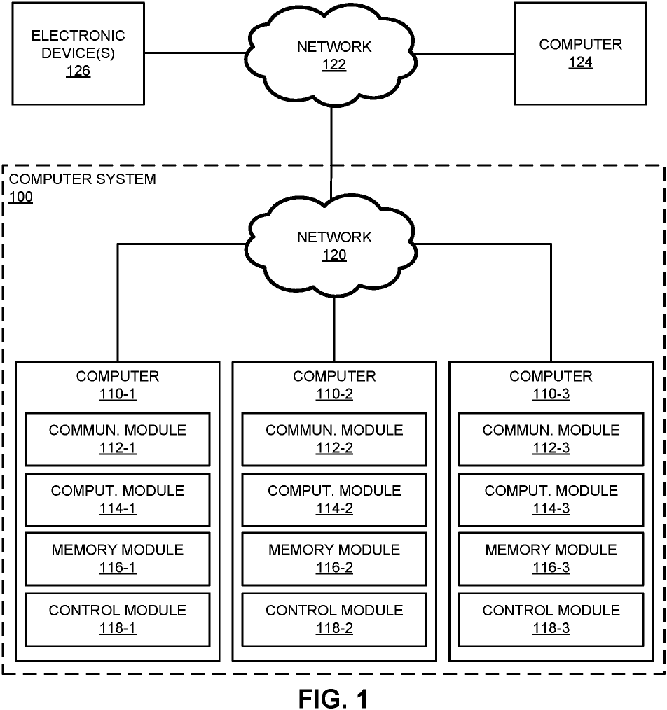

We now describe the regularization techniques. FIG. 1 presents a block diagram illustrating an example of a computer system 100. This computer system may include one or more computers 110. These computers may include: communication modules 112, computation modules 114, memory modules 116, and optional control modules 118. Note that a given module or engine may be implemented in hardware and/or in software.

Communication modules 112 may communicate frames or packets with data or information (such as information specifying a neural network or control instructions) between computers 110 via a network 120 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 112 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3rd Generation Partnership Project of Sophia Antipolis, Valbonne, France), LTE Advanced (LTE-A), a fifth generation or 5G communication protocol, other present or future developed advanced cellular communication protocol, or another type of wireless interface. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 110 (such as computer 110-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 1 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. In some embodiments, the communication between the components may use multi-user transmission (such as orthogonal frequency division multiple access or OFDMA).

Moreover, computation modules 114 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 116 may access stored data or information in memory that local in computer system 100 and/or that is remotely located from computer system 100. Notably, in some embodiments, one or more of memory modules 116 may access stored information in the local memory, such as information specifying a neural network. Alternatively or additionally, in other embodiments, one or more memory modules 116 may access, via one or more of communication modules 112, stored information in remote memory in computer 124, e.g., via network 120 and network 122. Note that network 122 may include: the Internet and/or an intranet. In some embodiments, the information is received from one of electronic devices 126 via network 120 and network 122 and one or more of communication modules 112. Thus, in some embodiments at least some of the information may have been received previously and may be stored in memory, while in other embodiments at least some of the information may be received in real-time from computer 124 or one of electronic devices 126.

While FIG. 1 illustrates computer system 100 at a particular location, in other embodiments at least a portion of computer system 100 is implemented at more than one location. Thus, in some embodiments, computer system 100 is implemented in a centralized manner, while in other embodiments at least a portion of computer system 100 is implemented in a distributed manner.

Moreover, in some embodiments, the one or more electronic devices 126 may include local hardware and/or software that performs at least some of the operations in the renormalization techniques. Furthermore, a given one of electronic devices 126 may execute the generated ALAP-AE neural network (such as using one or more processors and/or one or more GPUs). In some embodiments, at least some of the operations in the regularization techniques may be implemented using program instructions or software that are executed in an environment on one of electronic devices 126, such as: an application executed in the operating system of one of electronic devices 126, as a plugin for a Web browser or an application tool that is embedded in a web page and that executes in a virtual environment of the Web browser (e.g., in a client-server architecture), etc. Note that the software may be a standalone application or a portion of another application that is resident on and that executes on one of electronic devices 126 (such as a software application that is provided by the one of electronic devices 126 or that is installed on and that executes on the one of electronic devices 126). Consequently, the regularization techniques may be implemented locally and/or remotely, and may be implemented in a distributed or a centralized manner.

Although we describe the computing environment shown in FIG. 1 as an example, in alternative embodiments, different numbers or types of components or electronic devices may be present. For example, some embodiments comprise more or fewer components, a different component, components may be combined into a single component, and/or a single component may be divided into two or more components. As another example, in another embodiment, different components perform at least some of the operations in the regularization techniques.

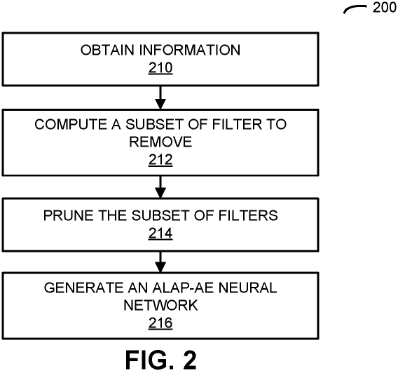

As discussed previously, it is often challenging to optimize a neural network to a particular compute environment. Moreover, as described further below with reference to FIGS. 2-6, in order to address these challenges computer system 100 may perform the regularization techniques. Notably, during the regularization techniques, one or more of optional control modules 118 may divide the analysis among computers 110. Then, a given computer (such as computer 110-1) may perform at least a designated portion of the analysis. In particular, computation module 114-1 may obtain (e.g., access) information (e.g., from memory module 116-1 or computer 124) specifying an initial AE neural network. Then, computation module 114-1 may perform operations in the regularization techniques. For example, as described further below with reference to FIGS. 2-6, computation module 114-1 may: compute a subset of filters associated with the initial AE neural network to remove based at least in part on a L1-norm loss function and weights associated with filters in initial AE neural network (such as a subset of filter that are not activated or that have a subset of the weights in the initial AE neural network that are less than a predefined value); prune the subset of the filters from the initial AE neural network; and generate the ALAP-AE neural network by retraining the initial AE neural network, where the retraining includes a student-teacher model in which the teacher includes the pruned initial AE neural network and the student includes the ALAP-AE neural network.

The computation may include regularizing the initial AE neural network to drive a subset of the weights associated with the subset of filters below the predefined value (such as 0). In some embodiments, the regularizing is based at least in part on a number of filters in a given layer of the initial AE neural network. For example, the subset of the weights associated with the subset of filters may be linearly driven below the predefined value based at least in part on the number of filters in the given layer. Moreover, the computation may be based at least in part on a type of compute environment in which the ALAP-AE neural network is intended to execute (such as a type of compute environment associated with one of electronic devices 126). For example, the type of compute environment may include: one or more processors, and/or one or more GPUs. (In generally, processors and GPUs intrinsically differ in hardware architecture and tensor compute with respect to parallelizability, latency, and throughput per electronic device, along with tensors transfer latency from processor(s) to GPU(s) and vice-vera.) Furthermore, the initial AE neural network and the ALAP-AE neural network may be trained using a common dataset. Additionally, a difference of an image quality of an output of the initial AE neural network and the ALAP-AE neural network may be less than a second predefined value. For example, the second predefined value may be zero. The image quality may include or may correspond to an FID. Note that a number of non-zero weights in the ALAP-AE neural network may be at least a factor of 10 less than a number of non-zero weights in the weights in the initial AE neural network.

After performing at least some of the operations in the regularization techniques, computation module 114-1 may output or provide information specifying the ALAP-AE neural network. Then, the one or more of optional control modules 118 may instruct one or more of communication modules 114 (such as communication module 114-1) to provide, via network 120 and 122, the information to, e.g., computer 124 or one or more of electronic devices 126. Alternatively or additionally, the one or more of optional control modules 118 may instruct one or more of computation modules 114-1 (such as computation module 114-1) to store the information in one or more of memory modules 116 (such as memory module 116-1).

In these ways, computer system 100 may automatically and accurately (e.g., with little or no loss of image quality and, more generally, the quality of an output from the ALAP-AE neural network) optimize the ALAP-AE neural network for use, e.g., on one or more of electronic devices 126. Notably, the ALAP-AE neural network may have a lightweight neural-network architecture that is customized to a compute environment in which the ALAP-AE neural network is intended to execute (such as computer 124 or one of electronic devices 110). This may significantly reduce the cost and complexity of this compute environment. In addition, computer system 100 may not need to have specialized (and expensive) processing capabilities to perform the regularization techniques.

While the preceding discussion illustrated the regularization techniques with an AE neural network, in other embodiments the regularization techniques may be used with a different type of neural network. For example, the different type of neural network may have: a different number of layers, a different number of filters or nodes, a different type of activation function, and/or a different architecture from an AE neural network. In some embodiments, the type of neural network may include or combine one or more convolutional layers, one or more residual layers and one or more dense or fully connected layers. Moreover, a given node or filter in a given layer in the type of neural network may include an activation function, such as: a rectified linear activation function (ReLU), a leaky ReLU, an exponential linear unit (ELU) activation function, a parametric ReLU, a tanh activation function, and/or a sigmoid activation function.

We now further describe the regularization techniques. FIG. 2 presents embodiments of a flow diagram illustrating an example of a method 200 for generating a second AE neural network, which may be performed by a computer system (such as at least a computer in computer system 100 in FIG. 1). Notably, the computer may include a computation device that performs method 200. For example, the computation device may include one or more of: a processor, one or more cores in a second processor, or another type of device that performs computation (such as one or more GPUs).

During operation, the computer system may obtain information (operation 210) specifying an initial AE neural network. Note that obtaining the initial AE neural network may include: accessing the information specifying the initial AE neural network stored in memory associated with the computer system; training the initial AE neural network; or receiving, from another computer system, the information specifying the initial AE neural network. Moreover, the initial AE neural network may transform an input image to a latent space, and from the latent space back to an output image.

Then, the computer system may compute a subset of filters associated with the initial AE neural network to remove (operation 212) based at least in part on a L1-norm loss function and weights associated with filters in initial AE neural network. Furthermore, the subset of filters associated with the initial AE neural network to remove are not activated or have a subset of the weights less than a predefined value. Additionally, the computation (operation 212) may include regularizing the initial AE neural network to drive a subset of the weights associated with the subset of filters below the predefined value (such as 0). In some embodiments, the regularizing is based at least in part on a number of filters in a given layer of the initial AE neural network. For example, the subset of the weights associated with the subset of filters may be linearly driven below the predefined value based at least in part on the number of filters in the given layer. Note that the computation may be based at least in part on a type of compute environment in which the ALAP-AE neural network is intended to execute. For example, the type of compute environment may include: one or more processors, and/or one or more GPUs.

Moreover, the computer system may prune the subset of the filters (operation 214) from the initial AE neural network.

Next, the computer system may generate the ALAP-AE neural network (operation 216) by retraining the initial AE neural network, where the retraining includes a student-teacher model in which the teacher includes the pruned initial AE neural network and the student includes the ALAP-AE neural network. Moreover, the initial AE neural network and the ALAP-AE neural network may be trained using a common dataset. Furthermore, a difference of an image quality of an output of the initial AE neural network and the ALAP-AE neural network may be less than a second predefined value. For example, the second predefined value may be zero. Note that the image quality may include or may correspond to an FID. In some embodiments, a number of non-zero weights in the ALAP-AE neural network may be at least a factor of 10 less than a number of non-zero weights in the weights in the initial AE neural network.

In some embodiments of method 200, there may be additional or fewer operations. Furthermore, there may be different operations. Moreover, the order of the operations may be changed, and/or two or more operations may be combined into a single operation.

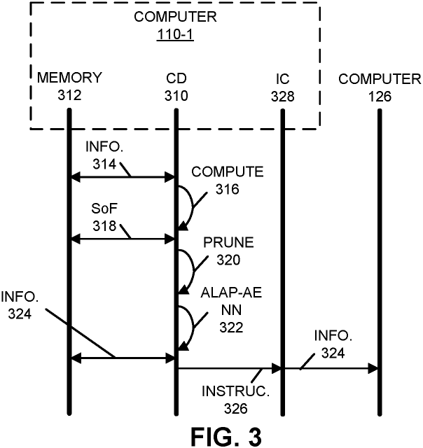

Embodiments of the regularization techniques are further illustrated in FIG. 3, which presents a drawing illustrating an example of communication among components in computer system 100 (FIG. 1). Notably, during the regularization techniques, a computation device (CD) 310 (such as a processor or a GPU) in computer 110-1 may access, in memory 312 in computer 110-1, information 314 specifying configuration instructions and hyperparameters for an initial AE neural network.

After receiving the configuration instructions and the hyperparameters, computation device 310 may compute 316 a subset of filters (SoF) 318 associated with the initial AE neural network to remove based at least in part on a L1-norm loss function and weights associated with filters in initial AE neural network. Then, computation device 310 may prune 320 the subset of the filters from the initial AE neural network. Next, computation device 310 may generate an ALAP-AE neural network (NN) 322 by retraining the initial AE neural network, where the retraining includes a student-teacher model in which the teacher includes the pruned initial AE neural network and the student includes the ALAP-AE neural network.

Furthermore, after or while performing the computations, computation device 310 may store results, including information 324 specifying the ALAP-AE neural network 322, in memory 312. In some embodiments, computation device 310 may provide instructions 326 to an interface circuit 328 in computer 110-1 to provide information 324 to another computer or electronic device, such as computer 126.

While FIG. 3 illustrates communication between components using unidirectional or bidirectional communication with lines having single arrows or double arrows, in general the communication in a given operation in this figure may involve unidirectional or bidirectional communication.

We now further describe the regularization techniques. These regularization techniques can be used to improve or optimize architecture of an AE neural network for a given compute electronic device that makes it as light as possible with respect to tensor compute required. Notably, the regularization techniques condense the neural-net channel-filter weight distribution to reduce the use of filters given a compute budget, and then prune the least activated filters and fine-tune using a student-teacher model, where the condensed AE acts as the teacher. The optimized AE neural network may be electronic device agnostic and may adapt the baseline architecture for the electronic device (e.g., the compute capabilities and cost budget of the electronic device). Furthermore, the regularization techniques may also allow for a trade-off between computation complexity, and synthesized image quality. Thus, the regularization techniques may: reduce compute costs via dynamic channel-filter condensing and pruning GAN-based AE for image generation; use a filter penalization loss for an improved filter-weight distribution for easy pruning across layers, and detection of a ‘hinge’ to get a minimum threshold for a particular filter structure to obtain an as-light-as-possible version of an AE; and provide ALAP-AE neural networks that achieve real-time inference capabilities (with equivalent FIDs) on processor-only, or processor-GPU compute versus generic AEs for conditional photo-realistic image generation.

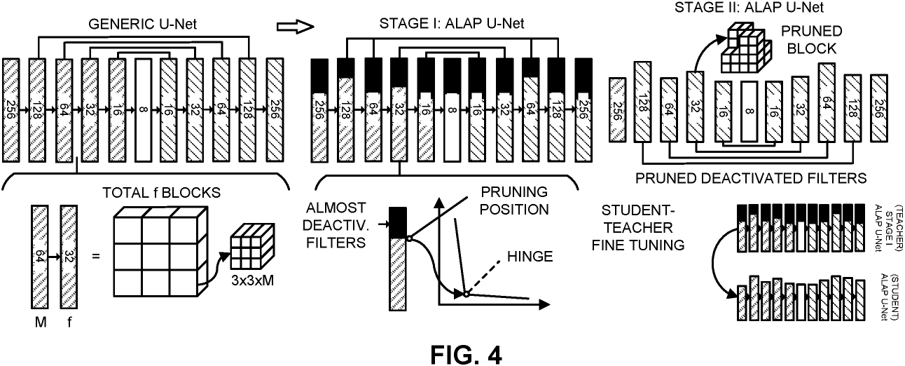

A generic AE generator G can learn to synthesize an image I from an input segmentation map, S ∈ {H ×W × 3}. In this pix2pixlike setup, a U-net may be used as the backbone generator, G. The optimized generator G∗ may aim to be as light as possible, such that the quality of generated images from both generators (G, G∗) is nearly equivalent, while G∗ can be deployed across diverse hardware (processors, GPUs, etc.), while being optimized for latency and image quality trade-off. The optimization condenses (or regularizes) filters used on different convolution layers of an AE (Stage I), and later prunes the least used filters (Stage II) and fine-tunes the pruned generator. This is illustrated in FIG. 4, which presents a drawing illustrating an example of a regularization technique for dynamic channel-filter condensing and pruning GAN-based AEs. Notably, in Stage I of the regularization techniques for dynamic channel-filter condensing and pruning GAN-based autoencoders for image generation, a generic U-net AE is trained with penalization, where the weight distribution (center-bottom) has several near-zero value channels that can be pruned. Then, in Stage II, the pruned network in fine-tuned in student-teacher manner, using the condensed model (from Stage I) as the teacher. In FIG. 4, note that M is a number of channels in an input feature map of a convolutional layer and f is a number of channels in an output feature map of a convolutional layer.

In some regularization techniques, there may be three levels at which sparsity regularization can be realized: fine weight- or kernel-level, medium channel-level, or coarse layer-level sparsity regularization. Fine weight- or kernel-level sparsity is flexible, and generalizes well with compression rates, but typically requires hardware-driven acceleration to realize the gain at inference time. While coarse layer-level sparsification usually does not require extra hardware or software to reduce compute, it is often more rigid as the whole layer needs to be removed. It is more effective when there are several layers in a convolutional neural network (CNN), such as the generator models that are used as an illustration in the present discussion.

Comparatively, medium channel-level sparsity typically provides a better trade-off between flexibility and ease of deployment. This pruning technique can be applied on any neural network with convolutional layers, and usually generates a sparser and easily deployable version of the original model. Channel-level sparsity often requires pruning all the adjacent connections associated with a particular channel, and can make it challenging to apply it directly on a pre-trained model because of generally nonexistent zero weight channels (inactivated weights) in the neural network. In order to alleviate the problem of nonexistent zero weight channels for sparsity regularization, in the disclosed regularization techniques a penalization loss is enforced in the training objective. Notably, a loss function is introduced that operates on absolute value of filter weights (which is sometimes referred to as an ‘L1-norm loss function’) and systematically pushes the filter weights towards zero during training.

Unlike other regularization techniques that regularize on an added scaling factors after convolution or on an adjacent scaling factor of batch normalization, the disclosed regularization techniques operate directly on the weights in a layer. Note that using extra scaling factors typically adds computational burden. Moreover, without batch-normalization in-between, scaling factors are usually not a good measure for channel importance, as both CNNs and scaling parameters are linear transformations. For example, the same result may be obtained by amplifying scale parameters and correspondingly reducing the magnitude of weights of that channel. Batch-norm specific techniques also typically increase the complexity of the approach when dealing with new techniques with preactivation structures and cross-connecting layers such as ResNets (from the Massachusetts Institute of Technology, of Cambridge, Massachusetts), and DenseNets (from Tsinghua University, Beijing, China). Furthermore, techniques designed with batch-norm can become unusable when working with batch-norm free architectures. The loss function in the disclosed regularization techniques directly operates on the magnitude of weights of filters, and can work with such batch-norm free architectures.

We now describe the channel-weight regularization in Stage I. Recent channel-pruning techniques use kernel magnitude as the criterion for relative importance across filters. In contrast, when a neural network is trained in the disclosed regularization techniques, a per channel importance factor γ is introduced that is equivalent to magnitude of the weights of the corresponding channels. Then, the neural network weights are trained and the importance factor is optimized with the objective to condense the weights to be as few channels as possible. This training objective for the ith layer is given by

$${L}_{i} = {\sum }_{j = 0}^{n} f \left(j\right) ∗ {\left‖{W}_{i , j}\right‖}_{1} \qquad \text{(1)}$$

where n is layer number in the network, j the channel number of the convolutional filter, and Wi,j is the filter weight of the ith layer and jth sorted channel. Note that is some embodiments, different channel regularization strategies may be used with j ∈ (0, n): uniform feature channel regularization, f (j) = 1.0; linear feature channel regularization, f (j) = j; and/or exponential feature channel regularization, f (j) = exp(0.01j).

Various types of f(x) used as a multiplier in Eq. 1 affect the penalization that incurs by activating (or having non-zero weight magnitude) more channels. For example, in case of linear feature channel regularization compared to uniform feature channel regularization, as more channels are added the penalization increases linearly, and forces the model to condense the weights to first few channels. Note that, because of a reduced increase in the value of exponential feature channel regularization for smaller channel indices, the model compression ratio achieved was least. In some embodiments, linear f(x) provided improved performance based on a trade-off between perceptual image quality scores and runtime improvements. However, uniform f(x) also performed well in this regard.

We now describe layer electronic device performance regularization in Stage I. GPU-based electronic devices typically exploit the benefits of tensor compute parallelism in convolution layers and process relatively large number of weight channels. In contrast, processor-based electronic devices carry out these operations sequentially and do not benefit from GPU-accelerated convolutional tensor compute speeds. Depending on the type of electronic device and the memory allocation, the relative speed of convolution operations across different spatial resolutions and feature map sizes may differ considerably. For example, a convolution(kernel=3, stride=2) at 8×8 resolution with 512 input and output channels may require 7.179 ms on a processor and 1.132 ms on a GPU. However, the same convolution at 16×16 resolution may take 21.12 ms (3×_{cost}) and 1.840 ms (1.6×cost) on a processor and a GPU, respectively. Similarly, for a convolution(kernel=3, stride=2) at 128×128 resolution with input channel 1, if the number of output channels is increased from 32 to 128, the runtime for a processor may be quadrupled (4×cost), while that for a GPU may remain nearly same. Based on this insight, the neural-network optimization in the disclosed regularization techniques may be electronic-device specific.

For model deployment, the compute electronic devices are usually fixed. Therefore, in some embodiments a runtime layer-level (which may depend on the electronic device) channel-regularization strategy may be used. Notably, the runtime for each layer across a particular electronic device may be calculated, and may be use as a multiplicative factor 1(i) for that layer to calculate the total penalization. In addition, the disclosed regularization techniques may allow electronic-device agnostic, or multiply-accumulate (MAC) operations-based, layer-level channel regularization. To this end, the multiplicative factor of each layer may be calculated based at least in part on corresponding MAC operations of that particular layer. The general formula for calculating total penalization is given by

$${L}_{P E N A L} = {\sum }_{i - 0}^{n} l \left(i\right) ∗ {L}_{i} \qquad \text{(2)}$$

Note that the objective function for a traditional minimax optimization problem for a GAN is min_{G} max_{D} L_{GAN}, where

$${L}_{G A N} = {E}_{y ∈ \text{Y}} \left[log \left(D \left(y\right)\right)\right] + {E}_{x ∈ \text{X}} \left[log \left(1 - \text{D} \left(\text{G} \left(\text{x}\right)\right)\right)\right] \qquad \text{3)}$$

where X corresponds to a random noise distribution, while Y corresponds to a real-image distribution. In the disclosed regularization techniques, L1 loss (between the ground-truth and the generated images) may be used for supervised training. Based on Eqs. 2 and 3, the training objective may be given by min_{G} max_{D}

$${L}_{G A N}^{A L A P} ,$$

where:

$${L}_{G A N}^{A L A P} = {L}_{G A N} + {L}_{l 1} + {L}_{P E N A L} \qquad \text{(4)}$$

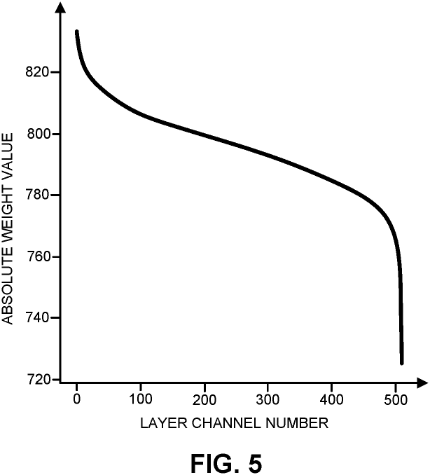

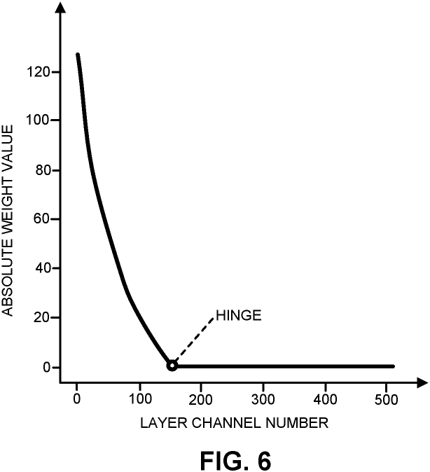

We now describe pruning and distillation in Stage II. After Stage I training based on Eqn. 4, a model is obtained with a considerable amount of inactivated (near-zero weight) channels. Because of penalization loss, the distinction between near-zero and important channels may be easily identifiable. The inclination or inflection point that shows the threshold between these two types of channels is sometimes referred to as the ‘hinge.’ FIGS. 5 and 6 present drawings illustrating an example of a weight distribution plot for a layer in a penalization or loss model, where the x axis indicates the channel number and the y axis indicates the absolute weights of the corresponding channel. Notably, in this example, channels of a layer in a Unet-64 linear penalization model are sorted by magnitude (or importance factor), and the hinge is identified at 150^{th} channel for this particular layer. In this way, an arbitrary guess or a global threshold on the number of channels to be pruned is not required, thereby making the layer as light as possible for the trained model. After identifying the ‘hinge,’ channels below the hinge are pruned. Along with pruning these channels, corresponding incoming and outgoing connections and weights across all layers are removed to obtain a compact neural network with fewer parameters, reduced runtime memory, and less compute operations.

This hinge-based pruning may have a minimal effect on the perceptual quality of generated images, which can also be compensated by fine tuning the pruned network via a student-teacher technique. In the student-teacher technique, the Stage-I trained model acts as the teacher model. In some embodiments, such as in some over-parameterized or low-weight penalization models summarized in Tables 1-4, the fine-tuned pruned network may provide higher perceptual scores than the generic neural network. After this stage, we finally obtain the optimized ALAP generator G∗.

TABLE 1

| | Unet-64 | Unet-32 | Unet-16 | ALAP-Unet-64 (Low Reg.) | ALAP-Unet-64 (High Reg.) |
|---|---|---|---|---|---|
| Frames Per Second or Runtime (Processor) | 7.3 | 25.9 | 70 | 16.4 | 25.2 |
| Frames Per Second (GPU) | 96 | 168 | 200 | 131 | 156 |
| FID | 47.3 | 58.7 | 74.5 | 37.9 | 48.6 |
| Parameters (Millions) | 41.83 | 10.46 | 2.62 | 9.5 | 3.74 |
| Memory (MB) | 294.7 | 110.68 | 47.70 | 135 | 97.23 |

TABLE 2

| | ResUnet-128 | ALAP-ResUnet-128 | Unet-192 | ALAP-Unet-192 |
|---|---|---|---|---|
| Frames Per Second (Processor) | 0.15 | 0.63 | 0.45 | 2.5 |
| Frames Per Second (GPU) | 3.43 | 6.1 | 7.8 | 25 |
| FID | 52.2 | 49.7 | 65.26 | 42.8 |
| Parameters (Millions) | 54 | 4.9 | 376 | 61.6 |

TABLE 3

| | Linear (High Reg.) | Uniform | Exponential | Linear (Low Reg.) |
|---|---|---|---|---|
| Frames Per Second (Processor) | 25.2 | 22.5 | 21.9 | 16.4 |
| Frames Per Second (GPU) | 156 | 149 | 144 | 131 |
| FID | 48.6 | 45.61 | 44.46 | 37.9 |

TABLE 4

| | Unet-64 | ALAP-Unet-64 (Processor) | ALAP-Unet-64 (GPU) | ALAP-Unet-64 MAC |
|---|---|---|---|---|
| Frames Per Second (Processor) | 7.3 | 28.6 | 26.1 | 25.2 |
| Frames Per Second (GPU) | 96 | 161 | 169 | 156 |
| FID | 47.3 | 51.48 | 51.61 | 48.6 |
| Parameters (Millions) | 41.83 | 3.04 | 3.18 | 3.74 |
| Memory (MB) | 294.7 | 92.44 | 95.17 | 97.23 |

In summary, the disclosed ALAP-AE, tensor compute reduction techniques may improve or optimize neural-network AEs for photo-realistic conditional image generation, for any compute electronic device, thereby achieving real-time inference capabilities on processor and/or GPU electronic devices. The disclosed reduction techniques may provide significant improvement over state-of-the-art techniques with respect to runtime and perceptual quality for photo-realistic image generation on processor electronic devices. The reduction techniques may create optimized models for processor as well as GPU electronic devices, and may provide efficacy for runtime performance and image quality.

In some embodiments, improved image-generation techniques with lower FID scores may be used. Moreover, the reduction techniques may preserve the complete identity attributes when the network is optimized versus generic versions of the AEs. Furthermore, the hinge may be manually or automatically selected during Stage II pruning. Additionally, the disclosed regularization techniques may use: improved perceptual losses during training to achieve lower FID scores, identity preserving losses, and/or automatically select the hinge via techniques, such as clustering, curve curvature modeling, etc.

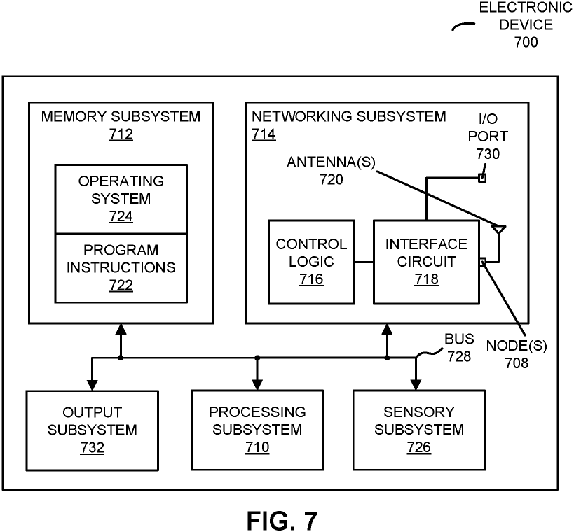

We now describe embodiments of an electronic device. FIG. 7 presents a block diagram illustrating an electronic device 700, such as one of electronic devices 126 or a computer in computer system 100 in FIG. 1. This electronic device includes processing subsystem 710, memory subsystem 712, and networking subsystem 714. Processing subsystem 710 includes one or more devices configured to perform computational operations (which are sometimes referred to as ‘computational devices’). For example, processing subsystem 710 can include one or more microprocessors, one or more application-specific integrated circuits (ASICs), one or more microcontrollers, one or more programmable-logic devices, one or more GPUs and/or one or more digital signal processors (DSPs).

Memory subsystem 712 includes one or more devices for storing data and/or instructions for processing subsystem 710 and networking subsystem 714. For example, memory subsystem 712 can include dynamic random access memory (DRAM), static random access memory (SRAM), and/or other types of memory. In some embodiments, instructions for processing subsystem 710 in memory subsystem 712 include: one or more program modules or sets of instructions (such as program instructions 722 or operating system 724), which may be executed by processing subsystem 710. Note that the one or more computer programs may constitute a computer-program mechanism. Moreover, instructions in the various modules in memory subsystem 712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 710.

In addition, memory subsystem 712 can include mechanisms for controlling access to the memory. In some embodiments, memory subsystem 712 includes a memory hierarchy that comprises one or more caches coupled to a memory in electronic device 700. In some of these embodiments, one or more of the caches is located in processing subsystem 710.

In some embodiments, memory subsystem 712 is coupled to one or more high-capacity mass-storage devices (not shown). For example, memory subsystem 712 can be coupled to a magnetic or optical drive, a solid-state drive, or another type of mass-storage device. In these embodiments, memory subsystem 712 can be used by electronic device 700 as fast-access storage for often-used data, while the mass-storage device is used to store less frequently used data.

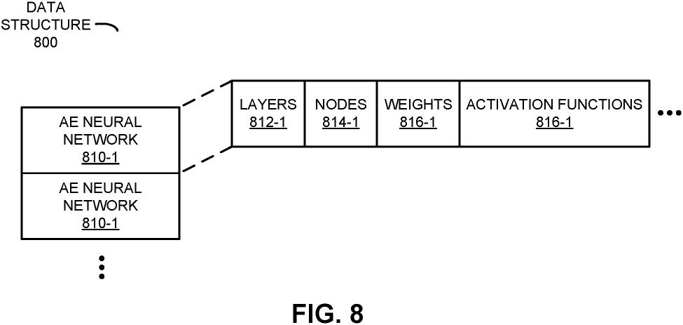

Memory subsystem 712 may store information that is used during the regularization techniques. This is shown in FIG. 8, which presents a block diagram illustrating a data structure 800 for use in conjunction with electronic device 700 (FIG. 7). This data structure may include information that specifies one or more AE neural networks 810, such as: layers 812-1, filters or nodes 814-1, weights 816-1, activation functions 818-1, etc.

In other embodiments, the order of items in data structure 800 can vary and additional and/or different items can be included. Moreover, other sizes or numerical formats and/or data can be used.

Referring back to FIG. 7, networking subsystem 714 includes one or more devices configured to couple to and communicate on a wired and/or wireless network (i.e., to perform network operations), including: control logic 716, an interface circuit 718, one or more antennas 720 and/or input/output (I/O) port 730. (While FIG. 7 includes one or more antennas 720, in some embodiments electronic device 700 includes one or more nodes 708, e.g., a pad, which can be coupled to one or more antennas 720. Thus, electronic device 700 may or may not include one or more antennas 720.) For example, networking subsystem 714 can include a Bluetooth networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 700 may use the mechanisms in networking subsystem 714 for performing simple wireless communication between the electronic devices, e.g., transmitting advertising or beacon frames and/or scanning for advertising frames transmitted by other electronic devices as described previously.

Within electronic device 700, processing subsystem 710, memory subsystem 712, and networking subsystem 714 are coupled together using bus 728. Bus 728 may include an electrical, optical, and/or electro-optical connection that the subsystems can use to communicate commands and data among one another. Although only one bus 728 is shown for clarity, different embodiments can include a different number or configuration of electrical, optical, and/or electro-optical connections among the subsystems.

In some embodiments, electronic device 700 includes a sensory subsystem 726 that includes one or more sensors that capture or perform one or more measurements of an individual, such as a user of electronic device 700. For example, sensory subsystem 726 may: capture one or more videos, capture acoustic information and/or perform one or more physiological measurements.

Moreover, electronic device 700 may include an output subsystem 732 that provides or presents information, such a photo-realistic image or virtual representation. For example, output subsystem 732 may include a display subsystem (which may include a display driver and a display, such as a liquid-crystal display, a multi-touch touchscreen, etc.) that displays the image or the virtual representation and/or one or more speakers that output sound associated with the image or the virtual representation (such as a speech).

Electronic device 700 can be (or can be included in) any electronic device with at least one network interface. For example, electronic device 700 can be (or can be included in): a desktop computer, a laptop computer, a subnotebook/netbook, a server, a mainframe computer, a cloud-based computer system, a tablet computer, a smartphone, a cellular telephone, a smart watch, a headset, electronic or digital glasses, headphones, a consumer-electronic device, a portable computing device, an access point, a router, a switch, communication equipment, test equipment, a wearable device or appliance, and/or another electronic device.

Although specific components are used to describe electronic device 700, in alternative embodiments, different components and/or subsystems may be present in electronic device 700. For example, electronic device 700 may include one or more additional processing subsystems, memory subsystems, networking subsystems, and/or feedback subsystems (such as an audio subsystem). Additionally, one or more of the subsystems may not be present in electronic device 700. Moreover, in some embodiments, electronic device 700 may include one or more additional subsystems that are not shown in FIG. 7. Also, although separate subsystems are shown in FIG. 7, in some embodiments, some or all of a given subsystem or component can be integrated into one or more of the other subsystems or component(s) in electronic device 700. For example, in some embodiments program instructions 722 are included in operating system 724.

Moreover, the circuits and components in electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 714 (such as a radio) and/or one or more functions of electronic device 700. Moreover, the integrated circuit may include hardware and/or software mechanisms that are used for transmitting wireless signals from electronic device 700 and receiving signals at electronic device 700 from other electronic devices. Aside from the mechanisms herein described, radios are generally known in the art and hence are not described in detail. In general, networking subsystem 714 and/or the integrated circuit can include any number of radios. Note that the radios in multiple-radio embodiments function in a similar way to the described single-radio embodiments.

In some embodiments, networking subsystem 714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, receiving the input data, etc.).

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While communication protocols compatible with Ethernet, Wi-Fi and a cellular-telephone communication protocol were used as illustrative examples, the described embodiments of the regularization techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the regularization techniques may be implemented using program instructions 722, operating system 724 (such as a driver for interface circuit 718) and/or in firmware in interface circuit 718. Alternatively or additionally, at least some of the operations in the regularization techniques may be implemented in a physical layer, such as hardware in interface circuit 718.

In the preceding description, we refer to ‘some embodiments.’ Note that ‘some embodiments’ describes a subset of all of the possible embodiments, but does not always specify the same subset of embodiments. Moreover, note that the numerical values provided are intended as illustrations of the regularization techniques. In other embodiments, the numerical values can be modified or changed.

Moreover, note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
a computation device;
memory configured to store program instructions, wherein, when executed by the computation device, the program instructions cause the electronic device to perform operations comprising:
obtaining information specifying an initial autoencoder (AE) neural network;
computing a subset of filters associated with the initial AE neural network to remove based at least in part on a L1-norm loss function and weights associated with filters in initial AE neural network;
pruning the subset of the filters from the initial AE neural network; and
generating a second AE neural network by retraining the initial AE neural network, wherein the retraining comprises a student-teacher model in which the teacher comprises the pruned initial AE neural network and the student comprises the second AE neural network.

2. The computer system of claim 1, wherein obtaining the initial AE neural network may include: accessing the information specifying the initial AE neural network stored in memory associated with the computer system; training the initial AE neural network; or receiving, from another computer system, the information specifying the initial AE neural network.

3. The computer system of claim 1, wherein the initial AE neural network is configured to: transform an input image to a latent space, and from the latent space back to an output image.

4. The computer system of claim 1, wherein the subset of filters associated with the initial AE neural network to remove are not activated or have a subset of the weights less than a predefined value.

5. The computer system of claim 1, wherein the computation comprises regularizing the initial AE neural network to drive a subset of the weights associated with the subset of filters below a predefined value.

6. The computer system of claim 1, wherein the regularizing is based at least in part on a number of filters in a given layer of the initial AE neural network.

7. The computer system of claim 6, wherein a subset of the weights associated with the subset of filters is linearly driven below the predefined value based at least in part on the number of filters in the given layer.

8. The computer system of claim 1, wherein the computation is based at least in part on a type of compute environment in which the second AE neural network is intended to execute.

9. The computer system of claim 8, wherein the type of compute environment comprises: one or more processors, one or more GPUs, or both.

10. The computer system of claim 1, wherein the initial AE neural network and the second AE neural network are trained using a common dataset.

11. The computer system of claim 1, wherein a difference of an image quality of an output of the initial AE neural network and the second AE neural network is less than a predefined value.

12. The computer system of claim 11, wherein the image quality comprises or corresponds to a Frechet Inception Distance (FID).

13. The computer system of claim 1, wherein a number of non-zero weights in the second AE neural network is at least a factor of 10 less than a number of non-zero weights in the initial AE neural network.

14. A non-transitory computer-readable storage medium for use in conjunction with a computer system, the computer-readable storage medium configured to store program instructions that, when executed by the computer system, causes the computer system to perform operations comprising:
obtaining information specifying an initial autoencoder (AE) neural network;
computing a subset of filters associated with the initial AE neural network to remove based at least in part on a L1-norm loss function and weights associated with filters in initial AE neural network;
pruning the subset of the filters from the initial AE neural network; and
generating a second AE neural network by retraining the initial AE neural network, wherein the retraining comprises a student-teacher model in which the teacher comprises the pruned initial AE neural network and the student comprises the second AE neural network.

15. The non-transitory computer-readable storage medium of claim 14, wherein the subset of filters associated with the initial AE neural network to remove are not activated or have a subset of the weights less than a predefined value.

16. The non-transitory computer-readable storage medium of claim 14, wherein the computation comprises regularizing the initial AE neural network to drive a subset of the weights associated with the subset of filters below a predefined value.

17. A method for generating a second autoencoder (AE) neural network, comprising:
by a computer system:
obtaining information specifying an initial autoencoder (AE) neural network;
computing a subset of filters associated with the initial AE neural network to remove based at least in part on a L1-norm loss function and weights associated with filters in initial AE neural network;
pruning the subset of the filters from the initial AE neural network; and
generating the second AE neural network by retraining the initial AE neural network, wherein the retraining comprises a student-teacher model in which the teacher comprises the pruned initial AE neural network and the student comprises the second AE neural network.

18. The method of claim 17, wherein the subset of filters associated with the initial AE neural network to remove are not activated or have a subset of the weights less than a predefined value.

19. The method of claim 17, wherein the computation comprises regularizing the initial AE neural network to drive a subset of the weights associated with the subset of filters below a predefined value.

20. The method of claim 17, wherein the computation is based at least in part on a type of compute environment in which the second AE neural network is intended to execute.
